(19) United States
(12) Patent Application Publication
(10) Pub. No.: US 2016/0153465 A1
(43) Pub. Date: Jun. 2, 2016

(54) AXIAL COMPRESSOR ENDWALL TREATMENT FOR CONTROLLING LEAKAGE FLOW THEREIN

(71) Applicant: General Electric Company, Schenectady, NY (US)

(72) Inventors: Sungho Yoon, Munich (DE); John David Stampfli, Greer, SC (US); Ramakrishna Venkata Mallina, Clifton Park, NY (US); Vittorio Michelassi, Munich (DE); Giridhar Jothiprasad, Clifton Park, NY (US); Ajay Keshava Rao, Bangalore (IN); Rudolf Konrad Selmeier, Fahrenzhausen (DE); Davide Giacché, Munich (DE); Ivan Malcevic, Schenectady, NY (US)

(21) Appl. No.: 14/556,452

(22) Filed: Dec. 1, 2014

(51) Int. Cl. F04D 29/52; F02C 3/04; F01D 11/08

(52) U.S. Cl. CPC F04D 29/526; F01D 11/08; F02C 3/04

(57) ABSTRACT

An axial compressor for a gas turbine engine including one or more endwall treatments for controlling leakage flow in the compressor. The one or more endwall treatments having a height formed in an interior surface of a compressor casing or a compressor hub and configured to return a flow adjacent a plurality of rotor blade tips or a plurality of stator blade tips to a cylindrical flow passage upstream of a point of removal of the flow. Each of the endwall treatments defining a front wall, a rear wall, an outer wall extending between the front wall and the rear wall, an axial overhang, an axial overlap, an axial lean angle and a tangential lean angle. The axial overhang extending upstream to overhang at least one of the at least one set of rotor blades or the at least one set of stator blades. The axial overlap extending downstream to overlap at least one of the at least one set of rotor blades or the at least one set of stator blades.

### BACKGROUND

The embodiments described herein relate generally to gas turbine engines and more particularly relate to an axial compressor endwall treatment for a gas turbine engine and a method for controlling leakage flow therein.

As is known, an axial compressor for a gas turbine engine may include a number of stages arranged along an axis of the compressor. Each stage may include a rotor disk and a number of compressor blades, also referred to herein as rotor blades, arranged about a circumference of the rotor disk. In addition, each stage may further include a number of stator blades, disposed adjacent the rotor blades and arranged about a circumference of the compressor casing.

During operation of a gas turbine engine using a multi-stage axial compressor, a turbine rotor is turned at high speeds by a turbine so that air is continuously induced into the compressor. The air is accelerated by the rotating compressor blades and swept rearwards onto the adjacent rows of stator blades. Each rotor blade/stator blade stage increases the pressure of the air. In addition, during operation a portion of the compressed air may pass downstream about a tip of each of the compressor blades and/or stator blades as a leakage flow. Such stage-to-stage leakage of compressed air as leakage flow may affect the stall point of the compressor.

Compressor stalls may reduce the compressor pressure ratio and reduce the airflow delivered to a combustor, thereby adversely affecting the efficiency of the gas turbine. A rotating stall in an axial-type compressor typically occurs at a desired peak performance operating point of the compressor. Following rotating stall, the compressor may transition into a surge condition or a deep stall condition that may result in a loss of efficiency and, if allowed to be prolonged, may lead to failure of the gas turbine.

The operating range of an axial compressor is generally limited due to weak flow in rotor tips, where the specific rotor stall point is determined by the operating conditions and compressor design. Prior attempts to increase the range of this operation and increase the stall margin have included flow control based techniques such as plasma actuation and suction/blowing near a blade tip. However, such attempts significantly increase compressor complexity and weight. Other attempts include end-wall treatments such as circumferential grooves, axial grooves, or the like. Early attempts have had a substantial impact on design point efficiency with very minimal benefit to stall margin.

Thus, there is a desire for an improved axial compressor for a gas turbine engine and a method for controlling leakage flow about one or more blade tips therein. Specifically, such a compressor may control leakage of compressed air through a carefully designed endwall treatment proximate the rotor blades and/or the stator blades that provides desired recirculation of the leakage flow. Such leakage control may increase operating range and surge margin of the compressor and the overall gas turbine engine while minimizing the detrimental impact on design point efficiency.

### BRIEF DESCRIPTION OF THE DISCLOSURE

Aspects and advantages of the disclosure are set forth below in the following description, or may be obvious from the description, or may be learned through practice of the disclosure.

In one aspect, a compressor is provided. The compressor includes a compressor endwall defining a generally cylindrical flow passage. The compressor endwall includes a compressor casing and a compressor hub disposed concentrically about and coaxially along a longitudinal centerline axis, at least one set of rotor blades, at least one set of stator blades and one or more endwall treatments having a radial height formed in an interior surface of the at least one of the casing or the hub. Each of the at least one set of rotor blades includes a plurality of rotor blades coupled to the compressor hub and extending between the compressor hub and the compressor casing and defining a blade passage there between each of the rotor blades. The compressor casing circumscribes the at least one set of rotor blades to define an annular gap between the compressor casing and a plurality of rotor blade tips of the plurality of rotor blades. Each of the at least one set of stator blades includes a plurality of stator blades coupled to the compressor casing and extending between the compressor casing and the compressor hub and defining a blade passage there between each of the stator blades. The stator blades are disposed relative to the compressor hub to define an annular gap between the compressor hub and a plurality of stator blade tips of the plurality of stator blades. The one or more endwall treatments are configured to return a flow adjacent one of the plurality of rotor blade tips or stator blade tips to the cylindrical flow passage upstream of a point of removal of the flow. Each of the endwall treatments defines a front wall including a first axial lean angle α₁ relative to the longitudinal centerline axis, a rear wall including a second axial lean angle α₂ relative to the longitudinal centerline axis, an outer wall extending between the front wall and the rear wall, an axial overhang extending upstream to overhang at least one of the at least one set of rotor blades or the at least one set of stator blades, an axial overlap extending downstream to overlap at least one of the at least one set of rotor blades or the at least one set of stator blades, a first tangential lean angle β₁ relative to a circumferential surface of the compressor endwall and a second tangential lean angle β₂ relative to the circumferential surface of the compressor endwall. One of the axial lean angle α₁ is not equal to the axial lean angle α₂ or the tangential lean angle β₁ is not equal to the tangential lean angle β₂.

In another aspect, an axial compressor is provided. The axial compressor includes a compressor endwall defining a generally cylindrical flow passage, one or more sets of rotor blades, one or more sets of stator blades and one or more discrete axial slots. The compressor endwall includes a compressor casing and a compressor hub disposed concentrically about and coaxially along a longitudinal centerline axis. Each of the one or more sets of rotor blades includes a plurality of rotor blades coupled to the compressor hub and extending between the compressor hub and the compressor casing and defining a blade passage there between each of the plurality of rotor blades. The compressor casing circumscribes the at least one set of rotor blades to define an annular gap between the compressor casing and a plurality of rotor blade tips of the plurality of rotor blades. Each of the one or more sets of stator blades includes a plurality of stator blades coupled to the compressor casing and extending between the compressor casing and the compressor hub and defining a blade passage there between each of the plurality of stator blades. The stator blades are disposed relative to the compressor hub to define an annular gap between the compressor hub and a plurality of stator blade tips of the plurality of stator blades. The one or more discrete axial slots are defined circumferentially about at least one of the compressor hub or the compressor casing. The one or more discrete axial slots are configured to control a flow of leakage air about at least one of the plurality of stator blades tips or the plurality of rotor blade tips. Each of the endwall treatments defines a front wall including a first axial lean angle α₁ relative to the longitudinal centerline axis, a rear wall including a second axial lean angle α₂ relative to the longitudinal centerline axis, an outer wall extending between the front wall and the rear wall, an axial overhang extending upstream to overhang at least one of the one or more sets of rotor blades or the one or more sets of stator blades, an axial overlap extending downstream to overlap at least one of the one or more sets of rotor blades or the one or more sets of stator blades, a first tangential lean angle β₁ relative to a circumferential surface of the compressor endwall and a second tangential lean angle β₂ relative to the circumferential surface of the compressor endwall. One of the axial overlap of each of the one or more discrete axial slots is 0% of a respective blade passage or the axial overhang of each of the one or more discrete axial slots is 0% of a respective blade passage.

In yet another aspect, an engine is provided. The engine includes a fan assembly and a core engine downstream of the fan assembly. The core engine includes a compressor, a combustor and a turbine. The compressor, the combustor and the turbine are configured in a downstream axial flow relationship. The compressor further includes a compressor endwall defining a generally cylindrical flow passage, at least one set of rotor blade, at least one set of stator blades and one or more endwall treatments. The compressor endwall includes a compressor casing and a compressor hub disposed concentrically about and coaxially along a longitudinal centerline axis. Each of the at least one set of rotor blades includes a plurality of rotor blades coupled to the compressor hub and extending between the compressor hub and the compressor casing. The compressor casing circumscribes the at least one set of rotor blades to define an annular gap between the compressor casing and a plurality of rotor blade tips of the plurality of rotor blades. Each of the at least one set of stator blades includes a plurality of stator blades coupled to the compressor casing and extending between the compressor casing and the compressor hub. The stator blades are disposed relative to the compressor hub to define an annular gap between the compressor hub and a plurality of stator blade tips of the plurality of stator blades. The one or more endwall treatments have a height formed in an interior surface of the casing and are configured to return a flow adjacent the plurality of rotor blade tips to the cylindrical flow passage upstream of a point of removal of the flow. Each of the one or more endwall treatments defines a front wall having a first axial lean angle α₁ relative to the longitudinal centerline axis, a rear wall having a second axial lean angle α₂ relative to the longitudinal centerline axis, an outer wall extending between the front wall and the rear wall, an axial overhang extending upstream to overhang at least one of the at least one set of rotor blades or the at least one set of stator blades, an axial overlap extending downstream to overlap at least one of the at least one set of rotor blades or the at least one set of stator blades, a first tangential lean angle β₁ relative to a circumferential surface of the compressor endwall and a second tangential lean angle β₂ relative to the circumferential surface of the compressor endwall, wherein at least one of axial lean angle α₁ is not equal to the axial lean angle α₂ or the tangential lean angle β₁ is not equal to the tangential lean angle β₂.

### BRIEF DESCRIPTION OF THE DRAWINGS

A full and enabling disclosure of the present disclosure, including the best mode thereof to one skilled in the art, is set forth more particularly in the remainder of the specification, including reference to the accompanying figures, in which:

FIG. 1 is a schematic longitudinal cross-section of portion of an aircraft engine including a compressor having endwall treatments, in accordance with one or more embodiments shown or described herein;

FIG. 2 is a schematic longitudinal cross-section of a portion of a compressor as known in the art;

FIG. 3 is a schematic longitudinal cross-section of a portion of the compressor of the aircraft engine of FIG. 1, including an endwall treatment, in accordance with one or more embodiments shown or described herein;

FIG. 4 is a schematic longitudinal cross-section of the compressor of FIG. 3, including an endwall treatment, in accordance with one or more embodiments shown or described herein;

FIG. 5 is a schematic isometric of a portion of the compressor of FIG. 4, including an endwall treatment, in accordance with one or more embodiments shown or described herein;

FIG. 6 is a schematic longitudinal cross-section of an alternate embodiment of a compressor, including an endwall treatment, in accordance with one or more embodiments shown or described herein;

FIG. 7 is a schematic longitudinal cross-section of an alternate embodiment of a compressor, including an endwall treatment, in accordance with one or more embodiments shown or described herein;

FIG. 8 is a schematic longitudinal cross-section of an alternate embodiment of a compressor, including an endwall treatment, in accordance with one or more embodiments shown or described herein;

FIG. 9 is a schematic axial cross-section of the compressor of FIG. 7 taken along line 9-9, including an endwall treatment, in accordance with one or more embodiments shown or described herein;

FIG. 10 is a schematic axial cross-section of an alternate embodiment of a compressor, including an endwall treatment, in accordance with one or more embodiments shown or described herein; and

FIG. 11 is a graphical representation illustrating the benefit of a compressor including the one or more endwall treatments as disclosed in accordance with one or more embodiments shown or described herein.

Corresponding reference characters indicate corresponding parts throughout the several views of the drawings.

### DETAILED DESCRIPTION

The present disclosure will be described for the purposes of illustration only in connection with certain embodiments; however, it is to be understood that other objects and advantages of the present disclosure will be made apparent by the following description of the drawings according to the disclosure. While preferred embodiments are disclosed, they are not intended to be limiting. Rather, the general principles set forth herein are considered to be merely illustrative of the scope of the present disclosure and it is to be further understood that numerous changes may be made without straying from the scope of the present disclosure.

Preferred embodiments of the present disclosure are illustrated in the figures with like numerals being used to refer to like and corresponding parts of the various drawings. In addition, reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. It is to be understood that the described inventive features may be combined in any suitable manner in the various embodiments. It is also understood that terms such as “top”, “bottom”, “outward”, “inward”, and the like are words of convenience and are not to be construed as limiting terms. It is to be noted that the terms “first,” “second,” and the like, as used herein do not denote any order, quantity, or importance, but rather are used to distinguish one element from another. The terms “a” and “an” do not denote a limitation of quantity, but rather denote the presence of at least one of the referenced item. The modifier “about” used in connection with a quantity is inclusive of the stated value and has the meaning dictated by the context (e.g., includes the degree of error associated with measurement of the particular quantity).

Embodiments disclosed herein relate to a compressor apparatus of an aircraft engine including one or more endwall treatments to control leakage flow there through the compressor. In contrast to known means of controlling leakage flow through a compressor, the endwall treatments as disclosed herein provide for an increase in the limit of operability of the compressor, minimizing in efficiency penalty of the compressor and a resultant delay in rotor stall.

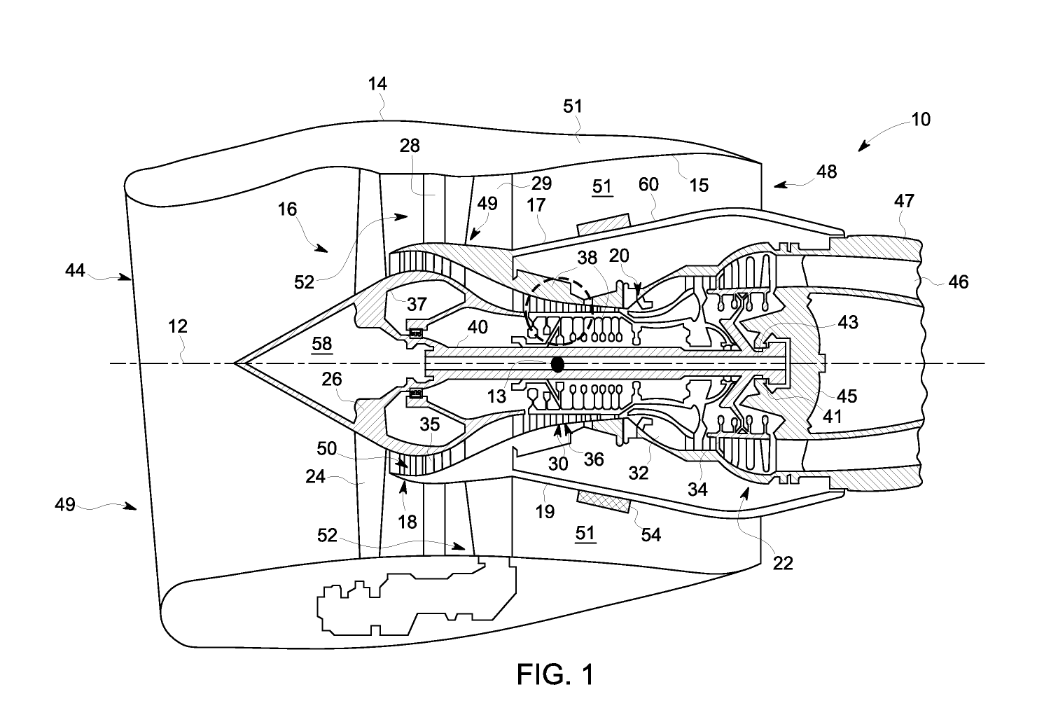

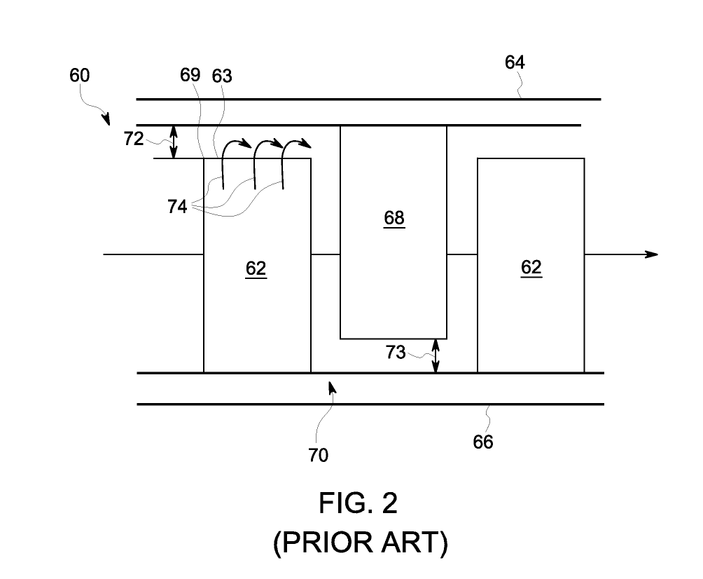

Referring to the drawings wherein identical reference numerals denote the same elements throughout the various views, FIGS. 1 and 2 depict a schematic illustration of an exemplary aircraft engine assembly 10 for purposes of example. The embodiments described herein are equally applicable to a stationary type of gas turbine such as a gas turbine used for industrial applications. It is noted that the portion of the engine assembly 10, illustrated in FIG. 2, is indicated by dotted line in FIG. 1. The engine assembly 10 has a longitudinal center line or longitudinal centerline axis 12 and an outer stationary annular fan casing 14 disposed concentrically about and coaxially along the longitudinal centerline axis 12. In addition, the engine assembly 10 has a radial axis 13. In the exemplary embodiment, the engine assembly 10 includes a fan assembly 16, a booster compressor 18, a core gas turbine engine 20, and a low-pressure turbine 22 that may be coupled to the fan assembly 16 and the booster compressor 18. The fan assembly 16 includes a plurality of rotor fan blades 24 that extend substantially radially outward from a fan rotor disk 26, as well as a plurality of structural strut members 28 and outlet guide blades (“OGVs”) 29 that may be positioned downstream of the rotor fan blades 24. In this example, separate members are provided for the aerodynamic and structural functions. In other configurations, each of the OGVs 29 may be both an aerodynamic element and a structural support for an annular fan casing. The booster compressor includes a plurality of rotor blades 35 that extend substantially radially outward from a compressor rotor disk, or hub, 37 coupled to a first drive shaft 40.

The core gas turbine engine 20 includes a high-pressure compressor 30, a combustor 32, and a high-pressure turbine 34. The high-pressure compressor 30 includes a plurality of rotor blades 36 that extend substantially radially outward from a compressor hub 38. The high-pressure compressor 30 and the high-pressure turbine 34 are coupled together by a second drive shaft 41. The first and second drive shafts 40 and 41 are rotatably mounted in bearings 43 which are themselves mounted in a fan frame 45 and a turbine rear frame 47. The engine assembly 10 also includes an intake side 44, defining a fan intake 49, a core engine exhaust side 46, and a fan exhaust side 48.

During operation, the fan assembly 16 compresses air entering the engine assembly 10 through the intake side 44. The airflow exiting the fan assembly 16 is split such that a portion 50 of the airflow is channeled into the booster compressor 18, as compressed airflow, and a remaining portion 52 of the airflow bypasses the booster compressor 18 and the core gas turbine engine 20 and exits the engine assembly 10 via a bypass duct 51, through the fan exhaust side 48 as bypass air. More specifically, the bypass duct 51 extends between an interior wall 15 of the fan casing 14 and an outer wall 17 of a booster casing 19. This portion 52 of the airflow, also referred to herein as bypass air flow 52, flows past and interacts with the structural strut members 28, the outlet guide blades 29 and a heat exchanger apparatus 54. The plurality of rotor fan blades 24 compress and deliver the compressed airflow 50 towards the core gas turbine engine 20. Furthermore, the airflow 50 is further compressed by the high-pressure compressor 30 and is delivered to the combustor 32. Moreover, the compressed airflow 50 from the combustor 32 drives the rotating high-pressure turbine 34 and the low-pressure turbine 22 and exits the engine assembly 10 through the core engine exhaust side 46.

Referring now to FIG. 2, illustrated schematically is a portion of a compressor 60, as generally known in the art and labeled as Prior Art. The compressor 60 includes a plurality of sets of rotor blades 62 that are circumferentially spaced and that extend radially outward towards a compressor casing 64 from a compressor hub 66. A plurality of sets of circumferentially-spaced stator blades 68 (of which only a single stator blade is shown) are positioned adjacent to each set of rotor blades 62, and in combination form one of a plurality of stages 70 (of which only a single stage is shown). Each of the stator blades 68 is securely coupled to the compressor casing 64 and extends radially inward to interface with the compressor hub 66. Each of the rotor blades 62 is circumscribed by the compressor casing 64, such that an annular gap 72 is defined between the compressor casing 64 and a rotor blade tip 63 of each blade in the set of rotor blades 62. Likewise, the stator blades 68 are disposed relative to the compressor hub 66, such that an annular gap 73 is defined between the compressor hub 66 and a stator blade tip 69 of each of the stator blades 68.

During operation, an operating range of the compressor 60 is generally limited due to leakage flow, as indicated by directional arrows 74, proximate the rotor blade tips 63. In addition, leakage flow (not shown) may be present proximate the stator blade tips 69. A specific rotor stall point is determined by the operating conditions and the compressor design. To increase the range of this operation, previous compressors have included endwall treatments (not shown), such as circumferential grooves, in an attempt to provide an increase in the operating range by redirecting and/or minimizing leakage flow 74.

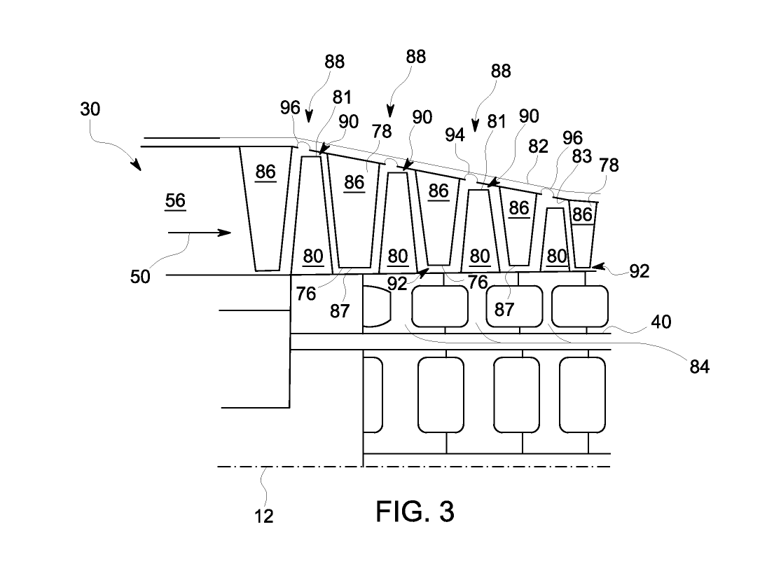

Referring more specifically to FIG. 3, illustrated is a portion of the novel compressor 30, as presented in FIG. 1. As illustrated, in the exemplary embodiment, the aircraft engine assembly 10, and more particularly the compressor 30 includes at least one set of rotor blades 76, each set comprising a plurality of rotor blades 80 that are circumferentially spaced and that extend radially outward towards a compressor casing 82 from a compressor hub, or rotor disk, 84 coupled to the first drive shaft 40. At least one set of stator blades 78, each set comprising a plurality of circumferentially-spaced stator blades 86, are positioned adjacent to each set of rotor blades 76, and in combination form one of a plurality of stages 88. The stator blades 86 are securely coupled to the compressor casing 82 and extend radially inward to interface with the compressor hub 84. Each of the plurality of stages 88 directs a flow of compressed air through the compressor 30. The rotor blades 80 are circumscribed by the compressor casing 82, such that an annular gap 90 is defined between the compressor casing 82 and a rotor blade tip 81 of each of the rotor blades 80. Likewise, the stator blades 86 are disposed relative to the compressor hub 84, such that an annular gap 92 is defined between the compressor hub 84 and a stator blade tip 87 of each of the stator blades 86.

As is typical in the art, each gap 90 and 92 is sized to facilitate minimizing a quantity of compressed air 50 that bypasses the rotor blades 80 and stator blade 86, respectively, defining the leakage flow 74 (FIG. 2). To provide for recirculation of that portion of compressed air 50 proximate the rotor blade tips 81 and/or stator blade tips 87, the novel compressor 30 disclosed herein includes one or more endwall treatments 94. As used herein, the term “endwall” is intended to encompass the compressor casing 82 and/or the compressor hub 84 and provide for a generally cylindrical flow passage 56.

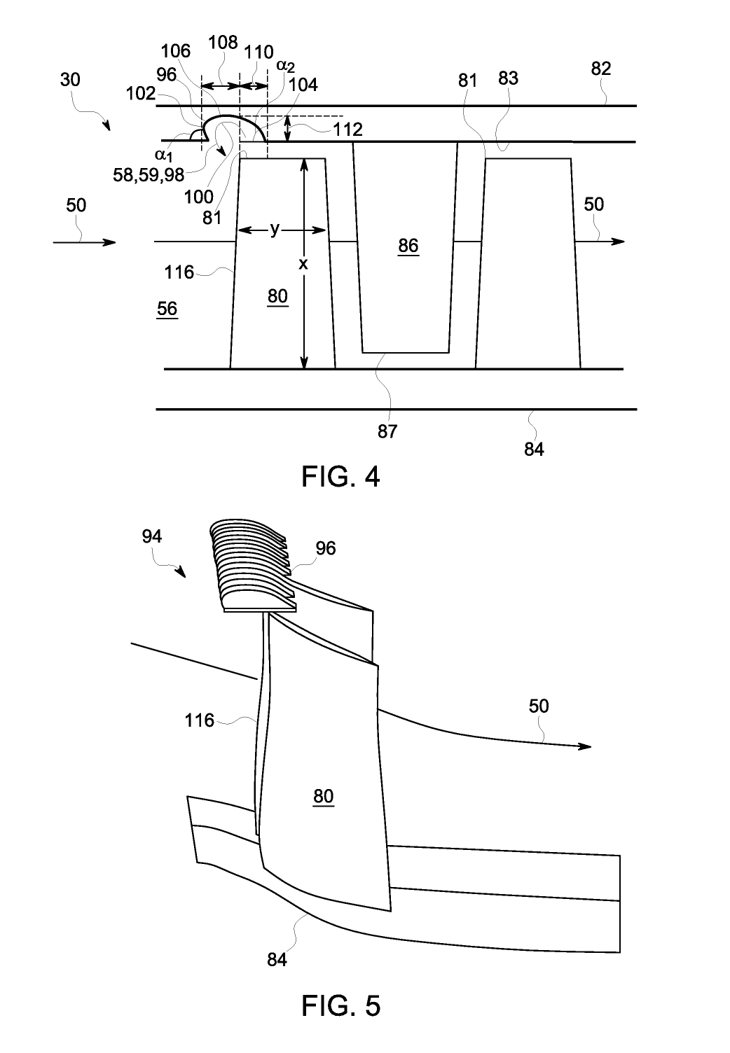

Referring now to FIGS. 4 and 5, FIG. 4 illustrates schematically a longitudinal cross-section of a portion of the compressor 30 including the one or more endwall treatments 94 (of which only one is shown). FIG. 5 illustrates in a schematic isometric view, the one or more endwall treatments 94 and positioning relative to a rotor blade 80, wherein a portion of the casing 82 is removed for illustrative purposes. As illustrated, in this particular embodiment, the one or more endwall treatments 94 are configured as a plurality of discrete slots 96 formed into an interior surface 83 of the compressor casing 82 and disposed circumferentially thereabout proximate the rotor blade tips 81. Each of the slots, of the plurality of slots 96, in general is aligned along the principal axis, and more particularly, the longitudinal centerline axis 12 (FIG. 1) so that a flow recirculation 98 in these slots is generally along this principal direction. As indicated by the flow recirculation directional arrow 98, the one or more endwall treatments 94 are configured to recirculate 98, and more particularly, return the flow 50 adjacent the plurality of rotor blade tips 81 to the cylindrical flow passage 56 upstream of a point of removal of the flow 50. Each slot 96 has a cross-section in the plane of this principal direction that facilitates flow recirculation 98 over the rotor blade tip 81. The position of each of the slots 96, orientation, cross-section definition and additional geometrical parameters may be optimized to provide specific solution for any application that desires an increase in stable operating range.

Specifically, in the exemplary illustrated embodiment, the one or more endwall treatments 94, and more particularly, the plurality of discrete slots 96 facilitates reducing the detrimental effect of leakage flows of compressed air between the compressor casing 82 and the rotor blade tip 81. More specifically, the plurality of discrete slots 96 facilitates the conversion of the uselessness of leakage flows into useful flows to increase the stall margin. During operation, the portion of air flow 50 flows into the aircraft engine assembly 10 through the fan intake 49 (FIG. 1) and towards the compressor 30. The stator blades 86 direct the compressed air towards the rotor blades 80. The compressed air extracts extra work input from the rotor blades 80 which rotate about the longitudinal centerline axis 12 of the compressor 30 while the stator blades 86 remain stationary and compressing the air flowing through each of the plurality of stages 88. In this manner, the rotor blades 80 cooperate with the adjacent stator blades 86 to impart kinetic energy to and compress the incoming flow of air 50, which is then delivered to the combustor 32. Other types of compressor configurations may be used.

The one or more endwall treatments 94, and more particularly the plurality of discrete slots 96, assist in delaying rotor stall by initially extracting weak tip flow through an aft segment 100 of a portion 58 of flow 50, also referred to herein as leakage flow, that is exposed to the rotor blade tip 81. The portion 58 of flow 50 is then recirculated and strengthened within each of the slots 96, and injected back into the main flow 50 ahead of the rotor blade 80 through the forward segment as a reinjected flow 59. It should be understood that the position of the plurality of slots 96 relative to the rotor blade tips 81, circumferential distribution about the casing 82 and repetition pattern of the plurality of slots 96 is shown only for illustration purposes only. In practice, the specific configuration of the one or more endwall treatments 94 is optimized for the application on which they are deployed.

Referring again to FIG. 4, the plurality of slots 96 are configured relative to the plurality of rotor blades 80, and more particularly the rotor blade tips 81. As illustrated, each of the plurality of slots 96 is defined by a front wall 102, a rear wall 104, and an outer wall 106, between the front wall 102 and the rear wall 104. Each of the plurality of slots 96 is further defined by an axial overhang 108, an axial overlap 110, a radial height 112, a first axial lean angle α₁ relative to the longitudinal centerline axis 12 (FIG. 1), a second axial lean angle α₂ relative to the longitudinal centerline axis 12 (FIG. 1), a first tangential lean angle and a second tangential lean angle, (described presently). In an embodiment, the axial overhang 108 extends upstream of the rotor blades 80, and more particularly extends in line with a forward blade edge tip 81 of the rotor blades 80 to the front wall 102. The axial overhang 108 may vary between −10% to 60% of the axial chord “y”. I should be understood that an axial overhang 108 of −10% of the axial chord “y” means that the front wall 102 of the slot 96 is located 10% downstream of the forward blade edge tip 81. The axial overlap 110 extends from forward blade edge tip 81 of the rotor blades 80 in a downstream direction, thereby essentially overlapping a portion of the rotor blades 80. The axial overlap 110 may vary between −10% to 100% of the axial chord “y”. It should be understood that an axial overlap 110 of −10% of the axial chord “y” means that the rear wall 104 of the slot 96 is located 10% upstream of the forward blade edge tip 81. In an embodiment, the radial height 112 of each of the plurality of slots 86 is approximately 5-50% of the span “x” of the rotor blades 80.

As previously indicated and illustrated, the front wall 102 and the rear wall 104 of each of the plurality of slots 96 are independently designed to incline at one or more angles, referred to herein as axial lean angles α₁ and α₂, with respect to the longitudinal centerline axis 12 of the casing 82. In an embodiment, the first axial lean angle α₁ and the second axial lean angle α₂ are between 10-170 degrees. In an embodiment, first axial lean angle α₁ and the second axial lean angle α₂ may be equal. In an embodiment, the first axial lean angle α₁ and the second axial lean angle α₂ may not be equal. In an embodiment first axial lean angle α₁ is aligned with the incoming main flow 50 in order to minimize the mixing loss between the incoming flow 50 and the re-injected flow 59 from each of the plurality of slots 96. On the other hand, the second axial lean angle α₂ is designed to effectively extract low momentum fluids from the main flow 50.

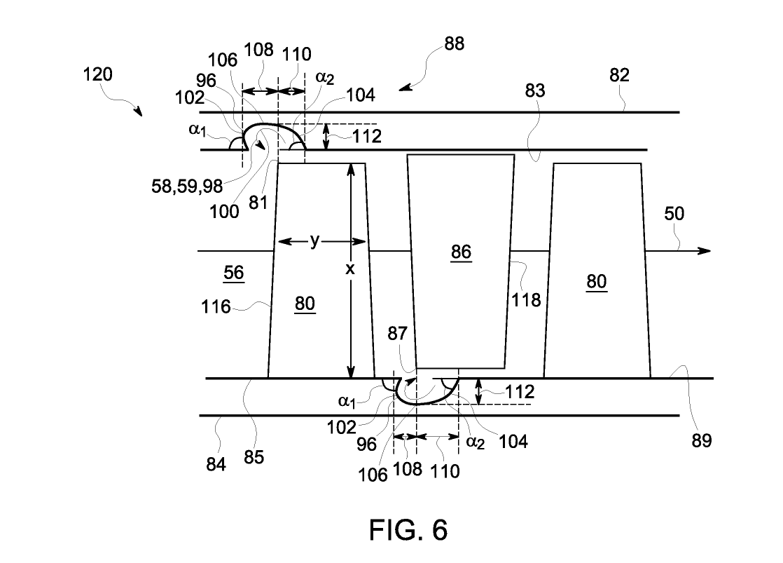

Referring now to FIG. 6, illustrated is portion of an alternate embodiment of a compressor 120, generally similar to compressor 30 of FIGS. 3-5. As previously indicated, like elements have like numbers throughout the disclosed embodiments. Similar to the previously disclosed embodiment, the compressor 120 includes a plurality of rotor blades 80 that are circumferentially spaced and that extend radially outward towards a compressor casing 82 from a compressor hub 84 to a rotor blade tip 81. A plurality of circumferentially-spaced stator blades 86 are positioned adjacent to each set of rotor blades 80, and in combination form one of a plurality of stages 88. The stator blades 86 are securely coupled to the compressor casing 82 and extend radially inward from toward the compressor hub 84 from the compressor casing 82 to a stator blade tip 87. Each of the plurality of stages 88 directs a flow of compressed air through the compressor 120

In this particular embodiment, to provide for recirculation of that portion 58 of compressed air 50 proximate the rotor blade tips 81 and the stator blade tips 87, the novel compressor 120 includes one or more endwall treatments 94, configured as a plurality of discrete slots 96 extending circumferentially about both the casing 82 and about the hub 84. More specifically, in this particular embodiment, the slots 96 are embedded in both the hub hardware, within an interior surface 89 of the hub 85, and the casing hardware, within an interior surface 83 of the casing 82. It should be understood, that anticipated is an embodiment including a plurality of slots 96 embedded in the hub hardware only.

The plurality of slots 96 are configured relative to the plurality of rotor blades 80, and more particularly the rotor blade tips 81 and the stator blades 86, and more particularly the stator blade tips 87. Similar to the previous embodiment, each of the plurality of slots 96 is defined by a front wall 102, a rear wall 104, and an outer wall 106, between the front wall 102 and the rear wall 104. Each of the plurality of slots 96 is further defined by an axial overhang 108, an axial overlap 110, a radial height 112, a first axial lean angle α₁, a second axial lean angle α₂, a first tangential lean angle and a second tangential lean angle (described presently).

With respect to the axial slot 96 configured proximate the rotor blades 80, the axial overhang 108 extends upstream of the rotor blades 80, and more particularly extends in line with a forward blade edge tip 81 of the rotor blades 80 to the front wall 102. The axial overhang 108 may vary between −10% to 60% of the axial chord “y”. It should be understood that an axial overhang 108 of −10% of the axial chord “y” means that the front wall 102 of the slot 96 is located 10% downstream of the forward blade edge tip 81. The axial overlap 110 extends from forward blade edge tip 81 of the rotor blades 80 in a downstream direction, thereby essentially overlapping a portion of the rotor blades 80. The axial overlap 110 may vary between −10% to 100% of the axial chord “y”. It should be understood that an axial overlap 110 of −10% of the axial chord “y” means that the rear wall 104 of the slot 96 is located 10% upstream of the forward blade edge tip 81.

With respect to the axial slot 96 configured proximate the stator blades 86, the axial overhang 108 extends upstream of the stator blades 86, and more particularly extends in line with an forward blade edge tip 87 of the stator blades 86 to the front wall 102. The axial overhang 108 may vary between −10% to 60% of the axial chord “y”. It should be understood that an axial overhang 108 of −10% of the axial chord “y” means that the front wall 102 of the slot 96 is located 10% downstream of the aft blade edge tip 87. The axial overlap 110 extends from the forward blade edge tip 87 of the stator blades 86 in a downstream direction, thereby essentially overlapping a portion of the stator blades 86. The axial overlap 110 may vary between −10% to 100% of the axial chord “y”. It should be understood that an axial overlap 110 of −10% of the axial chord “y” means that the rear wall 104 of the slot 96 is located 10% upstream of the forward blade edge tip 87. In an embodiment, the radial height 112 of each of the plurality of slots 96 is approximately 5-50% of the span “x” of the rotor blades 80 and the stator blades 86.

As previously indicated and illustrated, the front wall 102 and the rear wall 104 of each of the plurality of slots 96 are independently designed to incline at one or more angles, referred to as axial lean angles α₁ and α₂, with respect to the longitudinal centerline axis 12 of the casing 82. In an embodiment, the first axial lean angle α₁ and the second axial lean angle α₂ are between 10-170 degrees. In an embodiment, first axial lean angle α₁ and the second axial lean angle α₂ may be equal. In an embodiment, the first axial lean angle α₁ and the second axial lean angle α₂ may not be equal. In an embodiment first axial lean angle α₁ is aligned with the incoming main flow 50 in order to minimize the mixing loss between the incoming flow 50 and the re-injected flow 59 from each of the plurality of slots 96. On the other hand, the second axial lean angle α₂ is designed to effectively extract low momentum fluids from the main flow 50.

The embodiment disclosed in FIGS. 3-6, as illustrated, include one or more endwall treatments 94, in the form of a plurality of axial slots 96. As illustrated, each of the axial slots 96 includes a geometric shape having an overall curvature from the front wall 102 to the rear wall 104. Appropriate choice of curvature can minimize aerodynamic loss within slots. Each of the axial slots 96 may be optimized to provide specific solution for any application that desires an increase in stable operating range. Some of the aspects that may be optimized, include, but are not limited to: (i) the axial lean angle α₁ of the front wall 102 and axial lean angle α₂ of the aft wall 104 of the slot 96; (ii) the tangential lean angles (described presently) of the slot 96; (iii) the radial height 112 of the slot 96; (iv) a length of the axial overhang 108 and the length of the axial overlap 110; (v) a tangential spacing between slots 96 and within each slot 96 (described presently), (vi) a number of slots 96 spaced circumferentially about the endwall (described presently); (viii) an overall geometric cross-section of each slot 96 when viewed in a radial-axial plane; and (viii) any variation of the above parameters in the radial, axial and tangential direction.

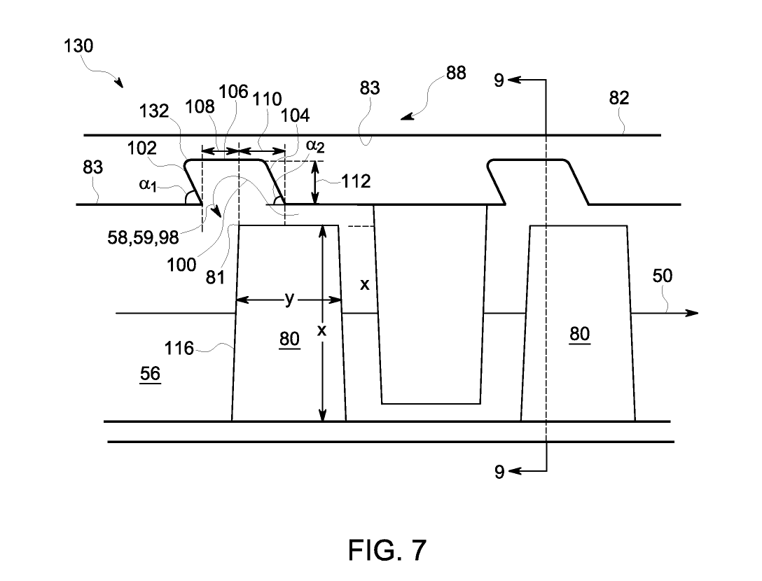

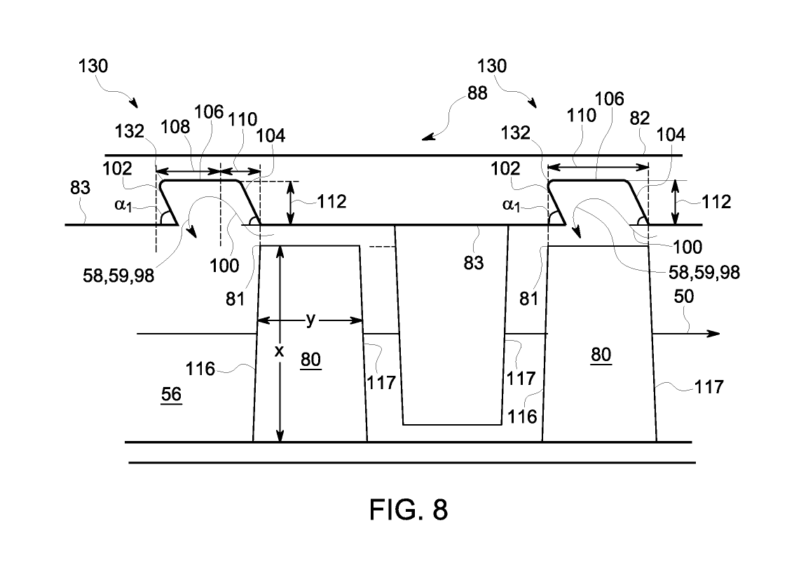

Referring now to FIGS. 7-9, illustrated are portions of alternate embodiments of a compressor 130, generally similar to compressor 30 of FIGS. 3-5. As previously indicated, like elements have like numbers throughout the disclosed embodiments. Similar to the previously disclosed embodiment, the compressor 130 includes a plurality of rotor blades 80 that are circumferentially spaced and that extend radially outward towards a compressor casing 82 from a compressor hub 84 to a rotor blade tip 81. A plurality of circumferentially-spaced stator blades 86 are positioned adjacent to each set of rotor blades 80, coupled to the compressor casing 82 and extend radially inward from toward the compressor hub 84 from the compressor casing 82 to a stator blade tip 87, and in combination form one of a plurality of stages 88. The compressor 132 is rotatable, as indicated by directional arrow 133, about a longitudinal centerline axis 12 (FIG. 1) of the engine 10 (FIG. 1).

In the embodiments of FIGS. 7-9, to provide for recirculation of that portion 58 of compressed air 50 proximate the rotor blade tips 81, the novel compressor 130 includes one or more endwall treatments, configured as a plurality of slots 132 extending circumferentially about the casing 82. In the illustrated embodiments, the plurality of slots 132 are shown as embedded in the casing hardware. It should be understood, that anticipated is an embodiment including a plurality of slots embedded in the hub hardware only, or a plurality of slots embedded in both the hub and casing hardware.

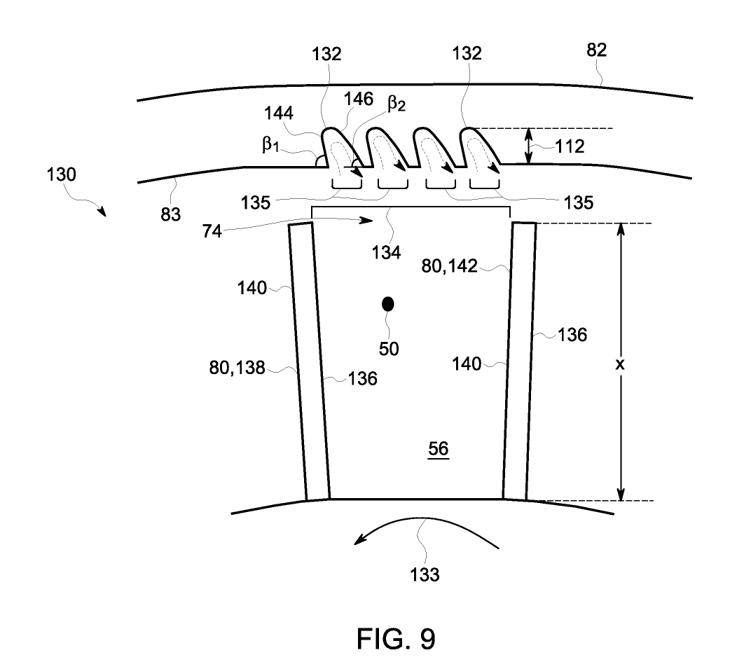

The plurality of slots 132 are configured relative to the plurality of rotor blades 80, and more particularly the rotor blade tips 81. In alternate embodiment, the plurality of slots 132 may be embedded in the hub hardware, or both the hub hardware and the casing hardware. Similar to the previously described embodiments, each of plurality of slots 132 is defined by a front wall 102, a rear wall 104, and an outer wall 106, between the front wall 102 and the rear wall 104. Each of the plurality of slots 132 is further defined by an axial overhang 108, an axial overlap 110, a radial height 112, a first axial lean angle α₁, a second axial lean angle α₂, a first tangential lean angle β₁ relative to a circumferential surface of the compressor endwall and a second tangential lean angle β₂ relative to a circumferential surface of the compressor endwall, as best illustrated in FIG. 9. Similar to the previously disclosed embodiment, the first axial lean angle α₁ and the second axial lean angle α₂ are between 10-170 degrees. In an embodiment, first axial lean angle α₁ and the second axial lean angle α₂ may be equal. In an embodiment, the first axial lean angle α₁ and the second axial lean angle α₂ may not be equal. In an embodiment first axial lean angle α₁ is aligned with the incoming main flow 50 in order to minimize the mixing loss between the incoming flow 50 and the re-injected flow 59 from each of the plurality of slots 96. On the other hand, the second axial lean angle α₂ is designed to effectively extract low momentum fluids from the main flow 50.

In the illustrated embodiment of FIG. 7, the axial overhang 108 extends upstream of the rotor blades 80, and more particularly extends in line with a forward blade edge tip 81 of the rotor blades 80 to the front wall 102. The axial overhang 108 may vary between −10% to 60% of the axial chord “y”. The axial overlap 110 extends from forward blade edge tip 81 of the rotor blades 80 in a downstream direction, thereby essentially overlapping a portion of the rotor blades 80. The axial overlap 110 may vary between −10% to 100% of the axial chord “y”. In an embodiment, the radial height 112 of each of the plurality of slots 86 is approximately 5-50% of the span “x” of the rotor blades 80.

As best illustrated in FIG. 7, the axial overhang 108 extends upstream of the rotor blades 80, and more particularly extends in line with a forward blade tip 81 of the rotor blades 80 to the front wall 102. The axial overlap 110 extends from the forward blade tip 81 of the rotor blades 80 in a downstream direction, thereby essentially overlapping a portion of the rotor blades 80.

As best illustrated in FIG. 8, in an alternate embodiment of a slot 132 as illustrated on the left rotor blade 80, the endwall treatment can be entirely located upstream of the forward edge blade tip 81. More particularly, when the slot 132 includes an axial overhang 108 extending upstream of the forward edge blade tip and a negative overlap 110 relative to the forward edge blade tip 81. In this case the role of the endwall treatment, and more particularly the slot 132, is to correct the portion 58 of flow 50 near the casing 82 before the flow 58 enters the blade passage (described presently).

As best illustrated in FIG. 8, and more particularly slot 132 as illustrated on the right rotor blade 80, the endwall treatment can be entirely located downstream of the forward edge blade tip 81. More particularly, when the slot 132 includes an axial overlap 110 extending downstream of the forward edge blade tip 81 and a negative overhang 108 relative to the forward edge blade tip 81. In this case the role of the endwall treatment, and more particularly the slot 96, is to extract weak leakage flows, and more particularly a portion 58 of flow 50 near a blade trailing edge 117 and strengthen the flow near the blade leading edge 116.

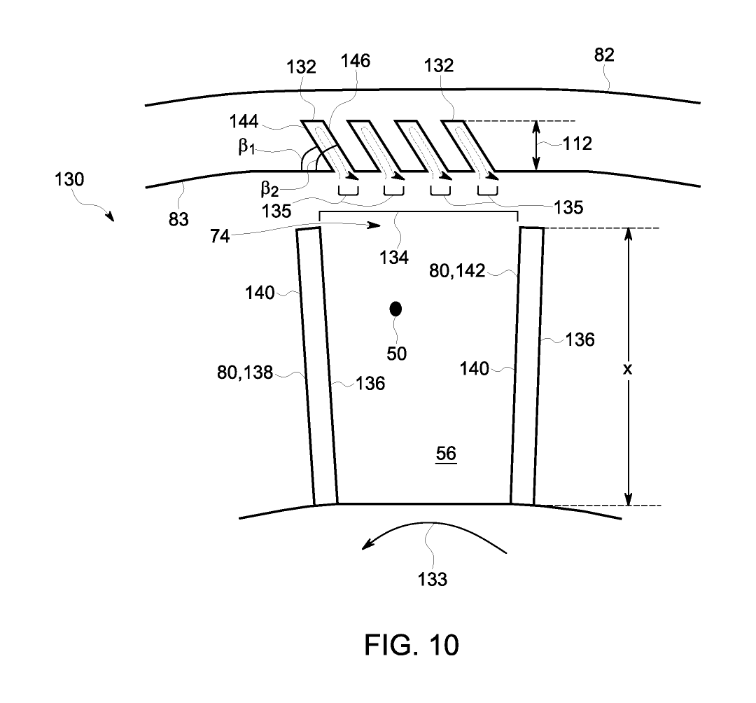

Referring more specifically to FIGS. 9 and 10, illustrated in radial cross-sectional views are a blade passage 134 (of which only one is illustrated) defined between adjacent rotor blades 80, and more particularly between a suction side 136 of a first blade 138 and pressure side 140 of an adjacently positioned second blade 142. In an embodiment, the spacing of the plurality of slots 132 circumferentially about the casing 82 is approximately 0-10 slots per blade passage 134, as best illustrated in FIGS. 9 and 10, but can vary for each blade passage 134. It should be also noted that in alternate embodiments, some blade passages may not include slots, whereas other blade passages include slots.

As illustrated in FIGS. 9 and 10, each of the plurality of slots 132 is further defined by a first sidewall 144 and a second sidewall 146. Generally similar to the first axial lean angle α₁ and the second axial lean angle α₁, the first sidewall 144 and the second sidewall 146 of each of the plurality of slots 132 are inclined at an angle to define a first tangential lean angle β₁ and a second tangential lean angle β₂ of the sidewalls 144, 146, relative to a circumferential surface of the compressor endwall of the casing 82. It should be understood that similar tangential lean angles may define the slots 132 when formed into the hub (as previously described). In an embodiment, each of the first tangential lean angles β₁ and a second tangential lean angles β₂ lie between 10-170 degrees relative to the circumference surface 83 of the casing 82. In an embodiment, the tangential lean angle 148 of both the first sidewall 144 and the second sidewall 146 may be equal. In an embodiment, the first tangential lean angle β₁ and a second tangential lean angle β₂ may not be equal and designed independently of one another. In designing the tangential lean angles, the tangential lean angle β₁ of the first side wall 144 is determined so as to effectively extract the leakage flows 74. The tangential lean angle β₂ of the second side wall 146 is determined to minimize the mixing loss with the main flow 50. As best illustrated in FIG. 9, each of the axial slots 132 includes a geometric shape having an overall curvilinear shape from the first side 144 to the second side wall 146. Appropriate choice of curvature may minimize aerodynamic loss within the slots 132, and more particularly minimize energy dissipation near sidewalls meeting at angles present within the slots 132. In an alternate embodiment, each of the axial slots 132 includes a geometric shape having an overall linear shape from the first side 144 to the second side wall 146, as best illustrated in FIG. 10.

The embodiments disclosed in FIGS. 7-10, include one or more endwall treatments, in the form of the plurality of axial slots 132. In an embodiment, each of the axial slots 132 includes a geometric shape having an overall linear shape from the front wall 102 to the rear wall 104 (FIG. 7) and an overall linear shape from the first sidewall 133 to the second sidewall 146 (FIG. 10). In another embodiment, each of the axial slots 132 includes a geometric shape having an overall linear shape from the front wall 102 to the rear wall 104 (FIG. 7) and an overall curvilinear shape from the first sidewall 144 to the second sidewall 146 (FIG. 9). In still another embodiment, each of the axial slots 132 includes a geometric shape having an overall curvilinear shape from the front wall 102 to the rear wall 104 (FIGS. 4-6) and an overall linear shape from the first sidewall 144 to the second sidewall 146 (FIG. 10). In yet another embodiment, each of the axial slots 132 includes a geometric shape having an overall an overall curvilinear shape from the front wall 102 to the rear wall 104 (FIGS. 4-6) and an overall curvilinear shape from the first sidewall 144 to the second sidewall 146 (FIG. 9). Some of the aspects that may be optimized, include, but are not limited to: (i) the axial lean angle α₁ of the front wall 102 and the axial lean angle α₂ of the aft wall 104 of the slots 132; (ii) the tangential lean angle β₁ of the first side wall 144 and the tangential lean angle β₂ of the second side wall 146 (iii) the radial height 112 of the slots 132; (iv) a length of the axial overhang 108 and the length of the axial overlap 110; (v) a tangential spacing between slots 132 and within each slot 132 (described presently), (vi) a number of slots 132 spaced circumferentially about the endwall; (viii) an overall geometric cross-section of each slot 132 when viewed in a radial-axial plane; and (viii) any variation of the above parameters in the radial, axial and tangential direction.

Referring again to FIGS. 9 and 10, a percentage of the slot area can be defined as slot non-metal area 135 relative to the blade passage area 134. In an embodiment, the percentage of the slot non-metal area 135 is between 10% and 90% of the blade passage area 134 and can vary in the radial direction. That is to say, the circumferential coverage of each slot 132 can vary in the radial direction. By varying the circumferential coverage in the radial direction, it is possible to minimize aerodynamic loss within the slots 132.

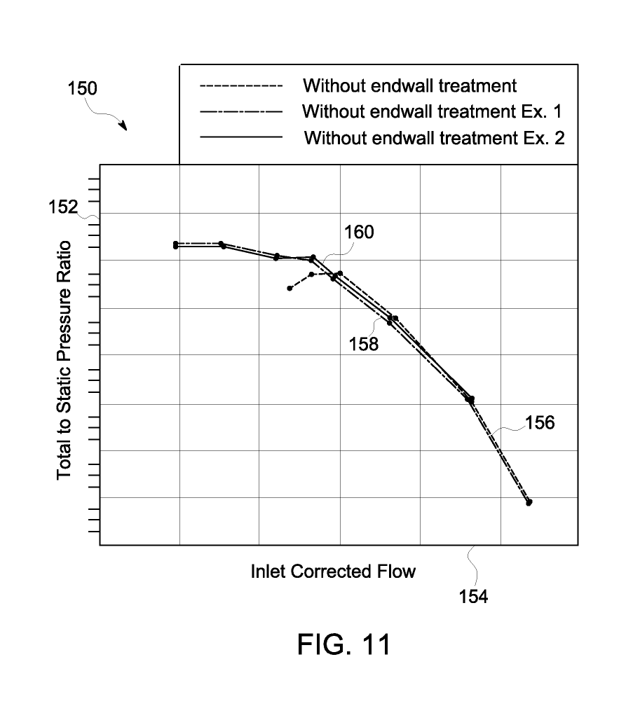

Referring now to FIG. 11, illustrated in an exemplary graphical representation, generally referenced 150, is the benefit of a compressor including the one or more endwall treatments 94 as disclosed herein, and more particularly when applied to a modern axial compressor rotor, in accordance with an exemplary embodiment. More specifically, graph 150 illustrates total to static pressure ratios (plotted in axis 152) with the inlet corrected flow (plotted in axis 154) of a compressor without endwall treatments, and in particular casing treatments, (plotted in line 156), a compressor with a first endwall treatment and in particular a first casing treatment, (plotted in line 158), in accordance with an embodiment described herein, and a compressor with a second endwall treatment and in particular a second casing treatment, (plotted in line 160), in accordance with an embodiment described herein. As indicated by line 158, the rotor is able continue to provide a pressure rise at a lower mass flow rate when compared with a compressor that does not include endwall treatments, as plotted at line 156. This extension stable operating range is only representative and can be optimized to be specific to a desired application. Further, these results were obtained using simulation of the unsteady flow with Computational Fluid Dynamics (CFD). Detailed investigation of the flow simulation results also confirms the primary flow mechanism. As previously indicated, the benefit in extending stable operating range and the impact on rotor efficiency depends on how the slot is designed relative to the rotor tip.

Accordingly, as disclosed herein and as illustrated in FIGS. 1-11, provided are various technological advantages and/or improvements over existing compressor endwall treatments, and in particular endwall treatments that provide for an increase in stall margin, without the negative loss in efficiency in a compressor. The proposed axial slots disposed circumferentially about an endwall of a compressor, as disclosed herein, have the potential to provide higher stall margins and operability range of the compressor. The axial slot parameters may be optimized and adjusted for the application on which they are deployed.

The proposed compressor endwall treatments, in addition, may provide an increase in hot day performance for the gas turbine engine, lower dependency on variable stator blades during startup, increase in performance of the rotors at the end of life clearances and lower reliance on transient bleed valves in aviation compressors during icing events.

Exemplary embodiments of an axial compressor endwall treatment and method of controlling leakage flow therein are described in detail above. Although the endwall treatments have been described with reference to an axial compressor, the endwall treatments as described above can be used in any axial flow system, including other types of engine apparatuses that include a compressor, and particularly those in which an increase in stall margin is desired. Other applications will be apparent to those of skill in the art. Accordingly, the axial compressor endwall treatment and method of controlling leakage flow as disclosed herein is not limited to use with the specified engine apparatus described herein. Moreover, the present disclosure is not limited to the embodiments of the axial compressor described in detail above. Rather, other variations of the axial, mixed and radial compressors including endwall treatment embodiments may be utilized within the spirit and scope of the claims.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

While there has been shown and described what are at present considered the preferred embodiments of the disclosure, it will be obvious to those skilled in the art that various changes and modifications can be made therein without departing from the scope of the disclosure defined by the appended claims.

What is claimed is:

1. A compressor comprising:
a compressor endwall defining a generally cylindrical flow passage, the compressor endwall comprising a compressor casing and a compressor hub disposed concentrically about and coaxially along a longitudinal centerline axis;
at least one set of rotor blades, each of the at least one set of rotor blades comprising a plurality of rotor blades coupled to the compressor hub and extending between the compressor hub and the compressor casing and defining a blade passage there between each of the rotor blades, the compressor casing circumscribing the at least one set of rotor blades to define an annular gap between the compressor casing and a plurality of rotor blade tips of the plurality of rotor blades;
at least one set of stator blades, each of the at least one set of stator blades comprising a plurality of stator blades coupled to the compressor casing and extending between the compressor casing and the compressor hub and defining a blade passage there between each of the stator blades, the plurality of stator blades disposed relative to the compressor hub to define an annular gap between the compressor hub and a plurality of stator blade tips of the plurality of stator blades; and
one or more endwall treatments having a radial height formed in an interior surface of at least one of the casing or the hub, the one or more endwall treatments configured to return a flow adjacent one of the plurality of rotor blade tips or the plurality of stator blade tips to the cylindrical flow passage upstream of a point of removal of the flow, each of the one or more endwall treatments defining a front wall including a first axial lean angle α₁ relative to the longitudinal centerline axis, a rear wall including a second axial lean angle α₂ relative to the longitudinal centerline axis, an outer wall extending between the front wall and the rear wall, an axial overhang extending upstream to overhang at least one of the at least one set of rotor blades or the at least one set of stator blades, an axial overlap extending downstream to overlap at least one of the at least one set of rotor blades or the at least one set of stator blades, a first tangential lean angle β₁ relative to a circumferential surface of the compressor endwall and a second tangential lean angle β₂ relative to the circumferential surface of the compressor endwall, wherein one of the axial lean angle α₁ is not equal to the axial lean angle α₂ or the tangential lean angle β₁ is not equal to the tangential lean angle β₂.

2. The compressor as claimed in claim 1, wherein the one or more endwall treatments comprise a plurality of discrete axial slots defined circumferentially about at least one of the compressor hub or the compressor casing.

3. The compressor as claimed in claim 2, wherein each blade passage includes 0-10 discrete axial slots.

4. The compressor as claimed in claim 1, wherein the one or more endwall treatments have a radial height ranging between 5-50% of a span of at least one of the plurality of rotor blades or the plurality of stator blades.

5. The compressor as claimed in claim 1, wherein the first axial lean angle α₁ and the second axial lean angle α₂ are in a range of 10 to 170 degrees.

6. The compressor as claimed in claim 1, wherein the first tangential lean angle β₁ and the second tangential lean angle β₂ are in a range of 10 to 170 degrees.

7. The compressor as claimed in claim 1, wherein the first axial lean angle, the second axial lean angle, the first tangential lean angle and the second tangential lean angle are not equal.

8. The compressor as claimed in claim 1, wherein the axial overhang is −10 to 60% of a blade chord length.

9. The compressor as claimed in claim 8, wherein the axial overhang is 0% a blade chord length.

10. The compressor as claimed in claim 1, wherein the axial overlap is −10 to 60% of a blade chord length.

11. The compressor as claimed in claim 10, wherein the axial overlap is 0% a blade chord length.

12. The compressor as claimed in claim 1, wherein a slot non-metal area is 10% to 90% of an area of the blade passage.

13. An axial compressor for a gas turbine engine, the axial compressor comprising:
a compressor endwall defining a generally cylindrical flow passage, the compressor endwall comprising a compressor casing and a compressor hub disposed concentrically about and coaxially along a longitudinal centerline axis;
one or more sets of rotor blades, each of the one or more sets of rotor blades comprising a plurality of rotor blades coupled to the compressor hub and extending between the compressor hub and the compressor casing and defining a blade passage there between each of the plurality of rotor blades, the compressor casing circumscribing the at least one set of rotor blades to define an annular gap between the compressor casing and a plurality of rotor blade tips of the plurality of rotor blades;
one or more sets of stator blades, each of the one or more sets of stator blades comprising a plurality of stator blades coupled to the compressor casing and extending between the compressor casing and the compressor hub and defining a blade passage therebetween each of the plurality of stator blades, the one or more sets of stator blades disposed relative to the compressor hub to define an annular gap between the compressor hub and a plurality of stator blade tips of the plurality of stator blades; and
one or more discrete axial slots defined circumferentially about at least one of the compressor hub or the compressor casing, the one or more discrete axial slots configured to control a flow of leakage air about at least one of the plurality of stator blades tips or the plurality of rotor blade tips, each of the one or more discrete axial slots defining a front wall including a first axial lean angle α₁ relative to the longitudinal centerline axis, a rear wall including a second axial lean angle α₂ relative to the longitudinal centerline axis, an outer wall extending between the front wall and the rear wall, an axial overhang extending upstream to overhang at least one of the one or more sets of rotor blades or the one or more sets of stator blades, an axial overlap extending downstream to overlap at least one of the one or more sets of rotor blades or the one or more sets of stator blades, a first tangential lean angle β₁ relative to a circumferential surface of the compressor endwall and a second tangential lean angle β₂ relative to the circumferential surface of the compressor endwall, and wherein one of the axial overlap of each of the one or more discrete axial slots is 0% of a respective blade passage or the axial overhang of each of the one or more discrete axial slots is 0% of a respective blade passage.

14. The compressor as claimed in claim 13, wherein each blade passage includes 0-10 discrete axial slots.

15. The compressor as claimed in claim 13, wherein the one or more endwall treatments have a radial height ranging between 5-50% of a span of at least one of the plurality of rotor blades or the plurality of stator blades.

16. The compressor as claimed in claim 13, wherein the first axial lean angle α₁, the second axial lean angle α₂, the first tangential lean angle β₁ and the second tangential lean angle β₂ are in a range of 10 to 170 degrees.

17. The compressor as claimed in claim 1, wherein a slot non-metal area is 10% to 90% of an area of the blade passage.

18. An engine comprising:
a fan assembly;
a core engine downstream of the fan assembly, the core engine including;
a compressor;
a combustor; and
a turbine, wherein the compressor, the combustor and the turbine are configured in a downstream axial flow relationship, the compressor further comprising:
a compressor endwall defining a generally cylindrical flow passage, the compressor endwall comprising a compressor casing and a compressor hub disposed concentrically about and coaxially along a longitudinal centerline axis;
at least one set of rotor blades, each of the at least one set of rotor blades comprising a plurality of rotor blades coupled to the compressor hub and extending between the compressor hub and the compressor casing, the compressor casing circumscribing the at least one set of rotor blades to define an annular gap between the compressor casing and a plurality of rotor blade tips of the plurality of rotor blades;
at least one set of stator blades, each of the at least one set of stator blades comprising a plurality of stator blades coupled to the compressor casing and extending between the compressor casing and the compressor hub, the at least one set of stator blades disposed relative to the compressor hub to define an annular gap between the compressor hub and a plurality of stator blade tips of the plurality of stator blades; and
one or more endwall treatments having a radial height formed in an interior surface of at least one of the compressor casing or the compressor hub, the one or more endwall treatments configured to return a flow adjacent the plurality of rotor blade tips to the cylindrical flow passage upstream of a point of removal of the flow, each of the one or more endwall treatments defining a front wall having a first axial lean angle α₁ relative to the longitudinal centerline axis, a rear wall having a second axial lean angle α₂ relative to the longitudinal centerline axis, an outer wall extending between the front wall and the rear wall, an axial overhang extending upstream to overhang at least one of the at least one set of rotor blades or the at least one set of stator blades, an axial overlap extending downstream to overlap at least one of the at least one set of rotor blades or the at least one set of stator blades, a first tangential lean angle β₁ relative to a circumferential surface of the compressor endwall and a second tangential lean angle β₂ relative to the circumferential surface of the compressor endwall, wherein at least one of axial lean angle α₁ is not equal to the axial lean angle α₂ or the tangential lean angle β₁ is not equal to the tangential lean angle β₂.

19. The engine of claim 18, wherein the first axial lean angle α₁, the second axial lean angle α₂, the first tangential lean angle β₁ and the second tangential lean angle β₁ are in a range of 10-170°.

20. The engine of claim 18, wherein the core engine is configured for use in an aircraft engine.
